(19) United States
(12) Patent Application Publication
(10) Pub. No.: US 2008/0226078 A1
(43) Pub. Date: Sep. 18, 2008

(54) ENABLING RECORDING AND COPYING DATA

(75) Inventors: Henry P. Gabryjelski, Seattle, WA (US); Christopher T. Carper, Cincinnati, OH (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/684,995

(22) Filed: Mar. 12, 2007

(51) Int. Cl. H04N 9/00

(52) U.S. Cl. 380/277; 713/156

(57) ABSTRACT

A data encryption key may be generated for encrypting data content. The data encryption key includes multiple portions. For example, the data encryption key may be generated by combining a drive seed and a media seed where the drive seed includes a value that is unique to the drive reading data content or a group of drives sharing the same drive seed. The media seed may include a value unique to the media from which data content may be read. The data encryption key thus generated may be unique to a combination of a specific drive or group of drives and a media or group of media.

### BACKGROUND

Secure data communication may be accomplished by encrypting data for transmission. Typically, a data key or data encryption key is employed to encrypt data. However, there is often a need to permit authorized clients to specify a data key while maintaining security and privacy in data communication. In a typical system, security cannot be efficiently maintained while permitting authorized clients to specify a data key.

Also, encrypting data for individual users may be excessively labor intensive if the number of users is large. However, at the same time, a data content owner may not wish to permit the individual users to copy data themselves as proprietary data (e.g., codes or commands) may be compromised and the individual users may utilize the comprised data to access the content on or copy the content to unauthorized devices.

Hence, a need exists to generate a data encryption key in which an authorized host client may specify the data encryption key while maintaining coherency of the data. Additionally, a need exists for maintaining data content security regardless of the media or device used.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is described in which a data key (also known as a data encryption key or data decryption key) is requested from a client host. A media may be blank or may not contain a media seed. The media seed may be determined based on the requested data encryption key and a drive or device seed associated with the drive for reading the media. The generated media seed may further be stored with the media.

In another example, a method is described in which a data encryption key is generated from combining a device seed corresponding to a device and a media seed corresponding to media or data content that may be read by the device. Data content may be encrypted using the generated data encryption key.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment for graphical layout operations.

FIG. 2 illustrates one example of a data key generated from two different sources.

FIG. 3 illustrates examples of generating data keys.

FIG. 4 illustrates one example of managing a data key and media at a drive.

FIG. 5 illustrates an example of partitioning of memory in a storage medium.

FIG. 6 is a flowchart illustrating one example of a process for creating a data key.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Systems described herein are provided as examples and not limitations. As those skilled in the art will appreciate, the present examples are suitable for application in a variety of different types of computing systems.

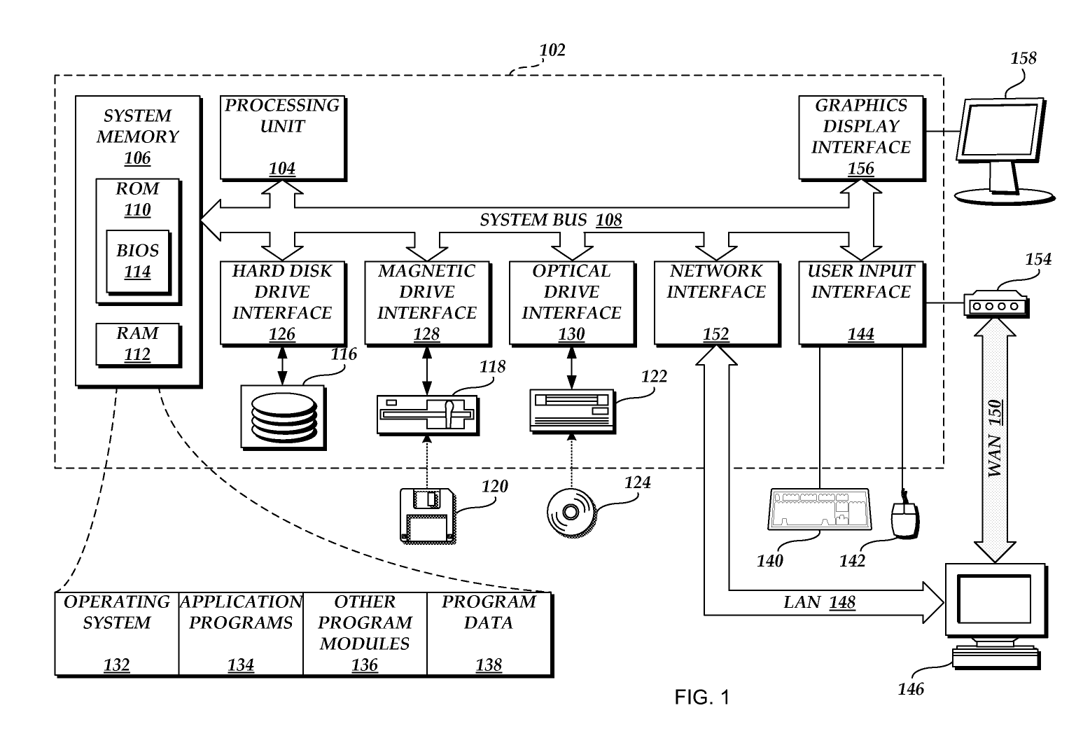

FIG. 1 illustrates an example of a suitable computing system environment or architecture in which computing subsystems may provide processing functionality. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The method or system disclosed herein is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the method or system includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media, a magnetic disk drive 118 that reads from or writes to a removable, nonvolatile magnetic disk 120, and an optical disk drive 122 that reads from or writes to a removable, nonvolatile optical disk 124 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126, and magnetic disk drive 118 and optical disk drive 122 are typically connected to the system bus 108 by a removable memory interface, such as interface 128 or 130.

The drives and their associated computer storage media discussed above and illustrated in FIG. 1, provide storage of computer readable instructions, data structures, program modules and other data for the computer 102. In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer 102 through input devices such as a keyboard 140 and pointing device 142, commonly referred to as a mouse, trackball or touch pad. Other input devices (not shown) may include a microphone, joystick, game pad, pen, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

Security in data communication and exchange has become an important issue. For example, if data content is communicated from a content owner to a user, the content owner may desire certain restrictions on re-distribution, copying, storing, or subsequent sharing of the content by the user. A method and system is described herein for enabling recording and/or copying of data content. Such recording and/or copying of data content may be performed on any type of media. For example, recording or copying of data content may be accomplished on removable or fixed media.

In one example, a data key may be associated with encryption or decryption of data content. Authorized entities in a system may communicate data content encrypted by the data key while other entities that are not authorized (i.e., lack the data key to decrypt the data content) may not access the encrypted data content. Hence, the encrypted data content being transmitted from one entity to another entity in a system is secure.

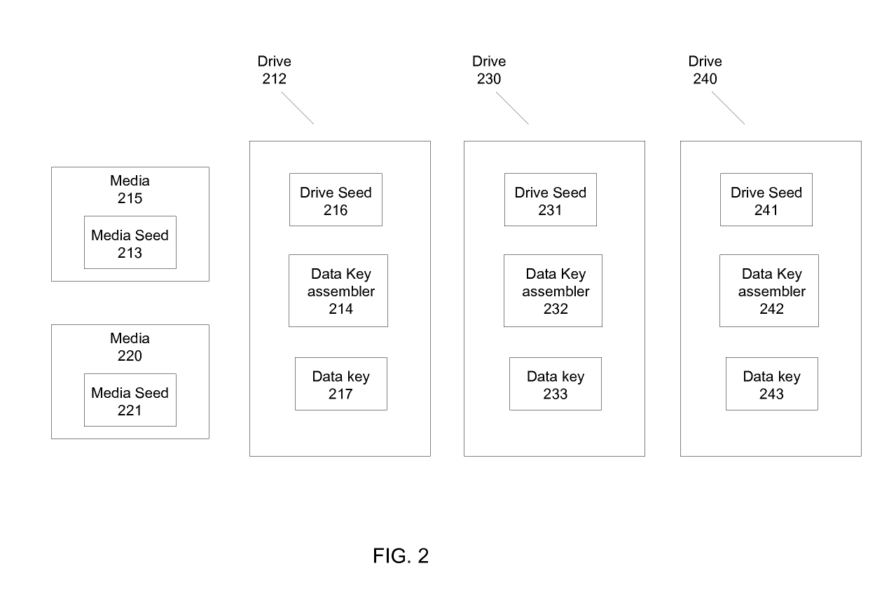

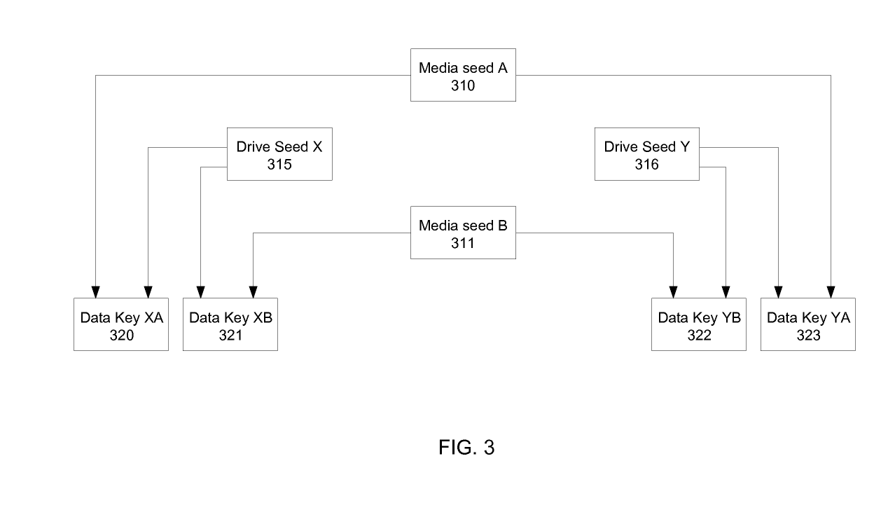

The data key may be created to include any number of individual portions. For example, the data key may include at least two portions where each of the two portions may be derived from different sources. FIGS. 2 and 3 illustrate examples of a data key generated from two different sources. FIGS. 2 and 3 are merely examples but any number of portions from any number or type of source may be used to create the data key.

As the example of FIG. 2 illustrates, a volume or media 215 may be associated with a drive 212. The volume or media 215 may include any type of content source and may further include a portion of a data key for encrypting or decrypting the associated data content. As FIG. 2 illustrates, the media 215 includes a media seed 213 that may be unique for the given media 215. FIG. 2 also illustrates a second media 220 containing a media seed 221. Media seed 221 may be different from media seed 213 as each of the media seeds (i.e., 221 and 213) in this example are unique to the respective media (i.e., 220 and 215, respectively).

Any of the media (215 or 220) may be associated with the drive 212. The drive 212 may include any component for accessing any provided media. For example, media 215 may be connected or otherwise associated with drive 212. The media seed 213 corresponding to media 215 may thus be accessed by drive 212. A data key may be constructed based, at least in part, on the media seed 213 as described herein.

In this example, the drive 212 includes a drive seed 216. The drive seed 216 in this example includes a portion of the data key to be generated by the drive 212. In addition, the drive seed 216 may be unique to the drive 212 and may be further private such that the drive seed 216 may not be available or otherwise accessible by an external entity. A second drive 230 may also be utilized. In this example, the second drive 230 may also include a drive seed 231 that is distinct from the drive seed 216 of drive 212. Hence, each of the drives (212 and 230) contains a unique drive seed (i.e., drive seed 216 and drive seed 231, respectively).

The drive seed 216 may be combined, connected, or otherwise associated with the media seed 213 received for media 215 to form a data key 217. For example, the drive 212 may include a data key assembler 214 which may receive the media seed 213 from media 215 and may combine the received media seed 213 with the drive seed 216 associated with the drive 212 to form the data key 217.

Similarly, if media communication or data exchange or transfer is established with media 215 and drive 230, the media seed 213 may be accessed by drive 230 which may further create or generate a data key based, at least in part, on the received media seed 213 from the media 215. In this case, a data key assembler 214 corresponding to the drive 230 may receive the media seed 213 from media 215 and may combine, connect, or otherwise associate the media seed 213 with the unique drive seed 231 associated with drive 230. The data key assembler 232 of drive 230 may thus generate data key 233 where the data key 233 includes both the media seed 213 portion and the drive seed 231 portion. Data may be encrypted or decrypted using the generated data key (e.g., data key 217 or data key 233), for example, during the transfer of the data from the drive 230.

In another example, the data may be left in the encrypted state when writing the data to the media. This would prevent a drive with a dissimilar drive seed from accessing the data, as it would be unable to determine the appropriate data key. In another example, the drive seed (e.g., drive seed 216 or drive seed 231) may be unique to a group of drives rather than a single drive. In this example, any number or type of devices may be selected for inclusion in a group of devices with a particular access to a desired media. Also, drives that do not share the drive seed with devices in the group having access to a desired media may not have access to the desired media. For example, media 215 may provide media seed 213 to drive 212, drive 230 and drive 240. In this example, drive 212 and drive 230 may be associated in that both drive 212 and drive 230 have the same drive seed. Hence, in this example, drive seed 216 and drive seed 231 are the same such that when media seed 213 is combined with drive seed 216 to form data key 217 (by data key assembler 214) and when media seed 213 is combined with drive seed 231 to form data key 233 by data key assembler 232, the resulting data keys are also the same. Hence, in this example, data key 217 includes media seed 213 and drive seed 216 and data key 233 includes media seed 213 and drive seed 231. Because in this example, drive seed 216 and drive seed 231 are the same, data key 217 and data key 233 are also the same. Hence, both drive 212 and drive 230 may have access to the desired data content.

However, in this example, drive 240 may include drive seed 241 that is different from either drive seed 216 (of drive 212) or drive seed 231 (of drive 230). In this case, media seed 213 may be received by drive 240 and the data key assembler 242 of drive 240 may combine the received media seed 213 with the drive seed 241 associated with drive 240. The resulting data key 243, however, is different from data key 217 and data key 233 in this example because the drive seed 241 of drive 240 is different from drive seed 216 or 231. Hence, in this example, drive 240 is not authorized to access the desired data content and, as a result, does not have access to the data content.

FIG. 3 illustrates examples of generating data keys. In this example, two media seeds associated with different media and two drive seeds associated with different drives are illustrated. Media seed A 310 and drive seed Y 316 may be combined to form data key YA 323. In this example, data key YA 323 includes both media seed A 310 and drive seed Y 316. Similarly, media seed A 310 may be combined with drive seed X 315 to generate data key XA 320. Media seed A 310 may be a unique value associated with a particular media or a particular group of media. Similarly, drive seed X 315 may be a unique value associated with a particular drive or group of drives. Drive seed Y 316 may also be a unique value associated with a particular drive or group of drives. If drive seed X 315 and drive seed Y 316 are different, then the resulting data keys (data key XA 320 and data key YA 323) are different even though a portion of each of data key XA 320 and data key YA 323 may be similar (i.e., the portion including media seed A 310).

Also in this example, media seed B 311 may be combined or otherwise associated with drive seed X 315 to form data key XB 321. Media seed B 311 may also be combined or associated with drive seed Y 316 (different from drive seed X 315 in this example) to form data key YB 322. Although media seed B 311 is included in both data key XB 321 and data key YB 322, each of the respective data keys (data key XB 321 and data key YB 322) contain different drive seeds (i.e., drive seed X 315 and drive seed Y 316, respectively, in this example).

Hence, in this example, a unique data key may be created that corresponds to a drive/media combination. The data keys in these examples would not correspond to either a non-authorized drive or a non-authorized media/volume. For example, if a drive associated with drive seed X 315 generates data key XA 320 with media seed A 310 and encrypts data based on data key XA 320, then the drive associated with drive seed Y 316 may be unable to access the encrypted data if the drive seed Y 316 is different from drive seed X 315.

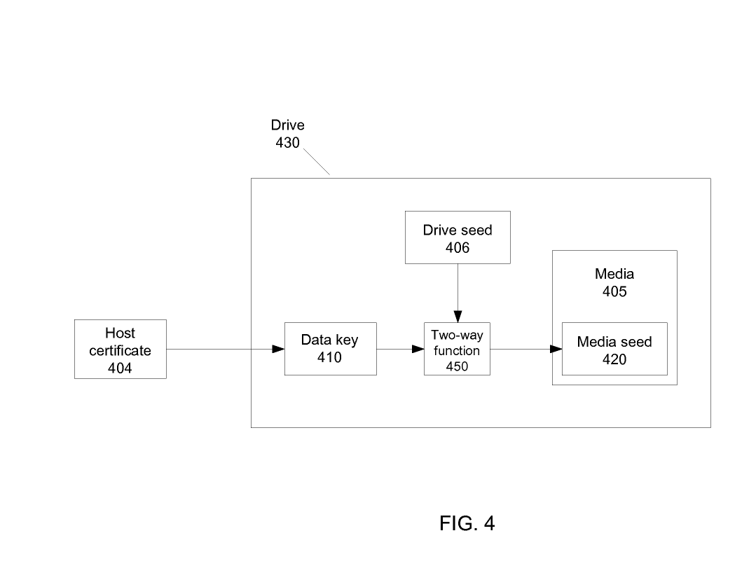

In another example, a client host may request a data key from a drive and associate the data key with a desired media. FIG. 4 illustrates one example of managing a data key and media at a drive. In this example, a blank media 405 may be provided and may be associated or connected to a drive 430. The blank media 405 may not contain data and may also not contain a media seed. In this case, a client host may request a data key for the drive 430 and the media 405. For example, a host certificate may include at least one bit (e.g., an authorization bit or the like) indicating that the client host has authorization to set or request a data key. Alternatively or additionally, the certificate may indicate the Data Key value(s) that the host is allowed to request. The device may check the authorization bit and may determine that the client host has authorization to set the data key and may assign the data key as requested.

The drive 430 further includes a drive seed 406. The drive seed 406 may be unique to drive 430 such that no other drive may share the drive seed 406. In addition, the unique drive seed 406 may be private such that external drives or other entities may not access the drive seed 406. Alternatively, when the drive 430 does not decrypt the data prior to writing the data to the media, the drive seed 406 may be shared among authorized drives or other devices and entities. In this case, drives, devices or entities sharing the drive seed 406 may have access to the data content. As one example, devices in a particular department of corporation may all have access to the same proprietary data content. In this case, each of the devices in the department of the corporation may share the same drive seed 406 such that any of the devices in the department may access the desired data content. Also, devices that are not in the department of the corporation (e.g., in a different department of the corporation or not within the corporation at all) may not access the desired data content because the devices outside of the group of devices with access to the desired data content lack access and do not share the drive seed 406. In another example, a drive in a group of authenticated drives may decrypt data content and store the decrypted data content on a storage medium or media. Also, the drive may set a flag or other indicator in a sector header on the media to indicate the status of the data. Other authenticated drives may subsequently access the stored decrypted data and may further determine the setting of the flag in the sector header. Responsive to the setting of the flag, the other authenticated drives may encrypt the data content prior to removing or transferring the data content from the drive.

In the example illustrated in FIG. 4, the media 405 lacks a media seed. The drive may generate a media seed 420 and may further associate the generated media seed 420 with the media 405. For example, the drive 430 may generate the media seed 420 based on the requested data key 410 and the drive seed 406 associated with the drive 430 and may further store the generated media seed 420 in the media 405. The media seed 420 may be generated from the data key 410 and drive seed 406 via any two-way function 450, for example. The media seed 420 may be determined from the requested data key 410 by comparing the data key 410 with the unique drive seed 406 associated with the drive 430. Based on components in the data key 410 not provided by the drive seed 406, a corresponding media seed 420 may be generated. As set forth above, the generated media seed 420 may be stored on the media. In this case, if the system is reset or interrupted, the state can be re-established through the stored media seed 420 now stored on the media 406. In one example, the two-way function 450 may include an exclusive OR (XOR) of the data key and drive seed (i.e., data key A drive seed) to obtain the media seed. The two-way function 450 may also include an XOR of the media seed and drive seed (i.e., media seed A drive seed) to obtain a data key. In another non-limiting example, the two-way function 450 may include an encryption/decryption function. For example, the data key 410 may be encrypted (or decrypted) via the drive seed 406 to obtain the media seed 420 or the media seed 420 may be decrypted (or encrypted) via the drive seed 406 to obtain the data key 410.

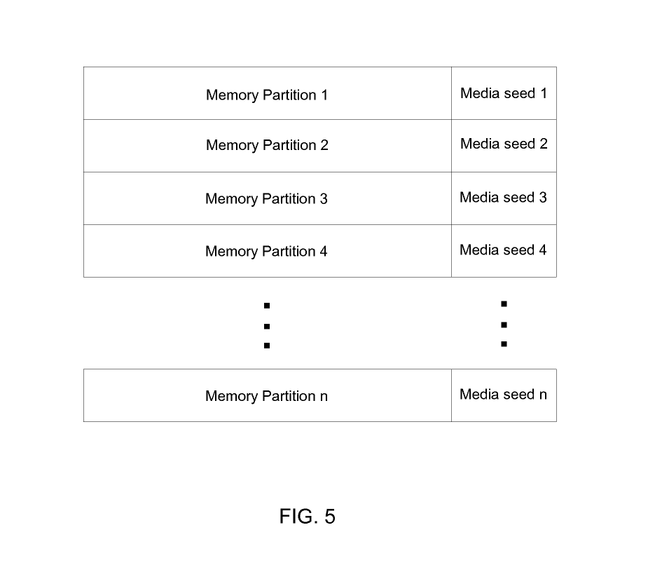

Also, memory in the media may be segmented or partitioned into any number of sections or partitions. For example, a storage medium may be partitioned into any number of tracks or sessions. Any of the partitions may have a separate or unique media seed. In another example, any subset of partitions may have a separate or unique media seed that may differ from a media seed corresponding to another subset of partitions. FIG. 5 illustrates an example of memory in a storage medium in which the memory is partitioned in n memory partitions (i.e., memory partition 1, memory partition 2, . . . memory partition n). In this example, each of the memory partitions has a corresponding media seed (i.e., media seed 1, media seed 2, . . . media seed n, respectively). In another example, one of the partitioned portions of memory may provide a corresponding media seed to a drive. The drive may have an associated drive seed which may be unique to the drive or may be unique to a group of drives. The drive may combine or otherwise associate the media seed from the partitioned portion of memory with the drive seed to form a data key. The data key may be used to encrypt data.

In yet another example, a track may be reserved on a storage medium such as a CD-R storage medium. The CD-R storage medium may contain any number of tracks and may also include a recording management area that lists details about each of the tracks on the CD-R. Each of the tracks on the CD-R may have a corresponding media seed where a media seed is set when reserving the track on the CD-R. When the media seed is set, it may be stored in the recording management area on a per-track basis. Thus, different portions or partitions may have a corresponding media seed that may be managed individually and independently from media seeds of other partitions on the storage medium.

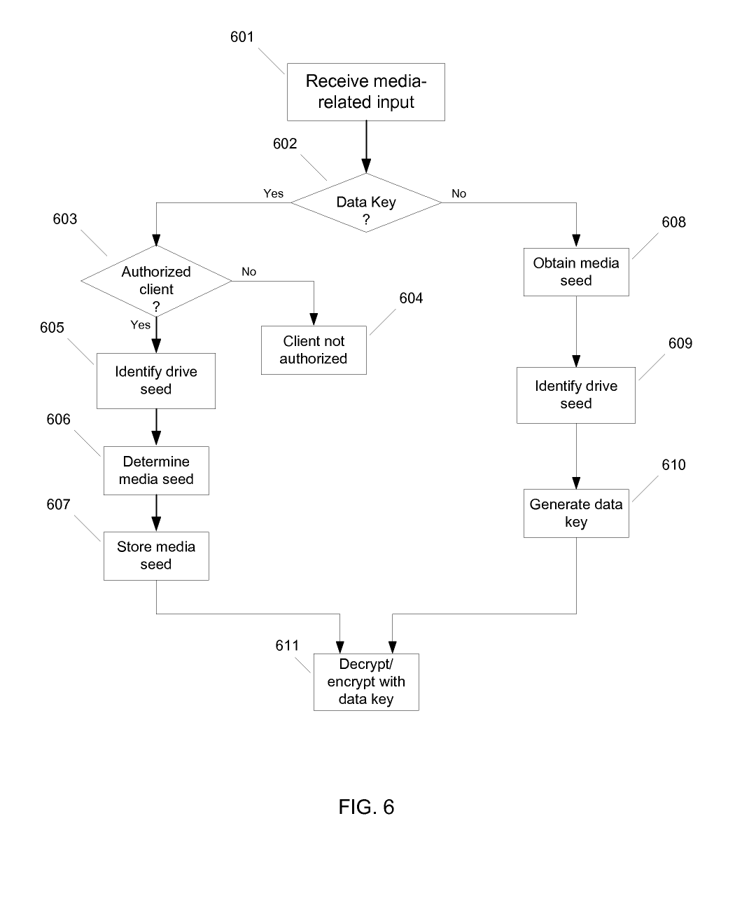

FIG. 6 is a flowchart illustrating one example of a process for creating a data key for encrypting or decrypting data content. The method illustrated in FIG. 6 is merely one example as certain steps may be performed in a different order, additional steps may be included and certain steps may be omitted entirely. In this example, media-related input is received in STEP 601. The media-related input may include, for example, a host certificate or may include a request for a data key. In one example, a request may be received from a client host for a particular data key to be used to encrypt or decrypt data content. If the media related input received in STEP 601 from a client host contains such a requested data key (“Yes” branch of STEP 602), the authenticity and authority of the client host is determined in STEP 603.

Different client hosts may have authority to set a data key while other client hosts may not have such an authority. If the client host providing a requested data key is not an authorized client host (“No” branch of STEP 603), the client host is not authorized (STEP 604) and the data key is not set to the requested data key. However, if the client host is authorized to request a data key (“Yes” branch of STEP 603), a data key may be generated based, at least in part, by the data key request. Authority of the host client may be accomplished in a variety of ways. For example, a host certificate received from the host client may contain at least one bit for determining authenticity of the host client. Based on a setting of the at least one bit in the host certificate, a client host may be determined to have authority to set the data key. For example if the at least one bit is set, the client host may have authority to set the data key while if the at least one bit is not set, the client host may not have authority to set the data key. This is merely an example, as any suitable method may be used to determine the authority of the client host.

In this example, the drive may include a drive seed. The drive seed may also be used, at least in part, to generate the data key. For example, the drive seed of the drive may be identified (STEP 605). The drive seed may be a unique, private value associated with the drive being used or may be a unique value corresponding to any number of drives. In STEP 606, the media seed may be determined. If the media associated with the drive does not contain a media seed, then the media seed may be determined by the drive based on the requested data key and the identified drive seed. For example, the drive seed may be preset and may not be altered. If this is the case, the media seed may be determined based on assigning values and parameters to the media seed corresponding to values and parameters contained in the requested data key but not contained within the drive seed. After generation of the media seed, the media seed is stored or otherwise associated with the media (e.g., the media seed is stored STEP 607).

Also in this example, the data key may be used to encrypt/decrypt data content. The data key used to encrypt/decrypt data content may further correspond to the data key requested by the host client. Also, a media seed corresponding to the requested data key may be generated and stored in association with the media.

In another example, the media associated with the drive may include a media seed. Also, a requested data key may not be received from the client host (“No” branch of STEP 602) or a client host may not have authority to set a data key. In this case, the media seed is obtained at the drive from the media (STEP 608). Also, the drive may have a corresponding unique and/or private drive seed (STEP 609) that may be used to generate a data key. The drive seed may be unique to the drive or may be unique to a group of drives or devices. The drive may create a data key for encrypting/decrypting data content based on the media seed and the drive seed. For example, the media seed obtained in STEP 608 from the media and the drive seed identified in STEP 609 may be combined or otherwise associated to create a data key (STEP 610). Thus, in this example, the data key contains the drive seed (from the drive) and the media seed (from the media). The data key may further be used to encrypt/decrypt data content. Also, the data key may itself be encrypted such that the encrypted data key may be transferred. This may, for example, increase security of the data key. Encryption of the data key may be performed in a variety of ways. As one example, the data key may be encrypted using a two-way authentication procedure in which the drive and the client are mutually trustworthy. For example, a bus key may be established for transmitting the encrypted data key across the bus. The bus key may be derived using any number of mechanisms, including, for example, an AACS (Advanced Access Content System) cryptographic method such as AACS-Auth( ) methods. When an encrypted data key is transmitted over the bus, the data key is more secure, integrity checks are available to protect against unauthorized modifications of the data key, for example, and replay attacks are minimized.

In another example, a data key may be generated for encrypting data content by combining a media seed corresponding to a media and a drive seed corresponding to the drive. The encrypted data may be stored on the media in encrypted form. In this case, if the media is transferred to another drive that does not share the same drive seed, the data content may not be available on the other drive. For example, the drive seed of the drive does not match the drive seed of the other drive. Therefore, the data key, which is generated from a combination of the media seed and the drive seed, also does not match the data key generated by the other drive. Hence, in this example, the data content may be locked to the media that is used on the device (or devices) having the same valid drive seed and may not be used on drives that do not share the same drive seed.

Also in this example, the use of the media may further be restricted to users within a group of drives in which the drives in the group are pre-seeded with the same media seed. For example, if a group of drives share the same drive seed and the data content is encrypted and stored on a media, access may be granted to a subset of drives in the group of drives having the media seed corresponding to the media pre-seeded. Thus, the drives in the subset of drives may receive the encrypted data and may further generate a data key from a pre-seeded media seed and the drive seed (from the drive itself). Only those drives that have the pre-seeded media seed in this example may access the data content.

Thus, in one example, a data key for encrypting/decrypting data content may be generated such that the generated data key contains a unique value corresponding to a media and drive combination. For example, a first value may be associated with a media and a second value may be associated with a drive. The first value and the second value may be combined to form a data key for encrypting/decrypting data content. If the first value is unique for the corresponding media and the second value is unique for the corresponding drive, the data key may be unique for the combination of the media and the drive. Hence, if either a different media or a different drive is used, the data key would not match with the combination of the different media and/or different drive.

Similarly, the first value may corresponding to any number of media or the second value may correspond to a group of (multiple) drives. For example, if the second value corresponds to multiple drives, then a data key generated from combining the first value and the second value may be used on any drive in the group of drives that have the same second value. Hence, if the media is used on any of the drives in the group of drives, any of the drives in the group of drives may determine the data key to be used to encrypt/decrypt the data content on the media. The encryption/decryption may be performed at any stage. For example, the drive may decrypt the data content internally or the drive may maintain the data content in an encrypted state such that a client may decrypt the data content as needed. Also, data may be written to the media in encrypted form. In this case, the drive may also write validation data (e.g., hash, crc, or the like) which may be added to data provided from the host. When such data is read back, the validation data may be matched with values expected for a given data key. If a match is not found, the drive may not read the corresponding data in the sector.

Also, in another example, a media may be blank or erased such that the media does not contain a media seed. In this example, a drive may generate a media seed and may store the generated media seed onto the media. For example, a data key may be requested from a host (aka client). The drive has a corresponding drive seed which is a value that may be combined with the media seed to form a data key for encrypting/decrypting data (e.g., bus level encryption). The drive seed may further be private to the drive and/or may be unique to the drive or to a group of authorized drives. Based on the requested data key and the drive seed already assigned to the drive, the drive may derive a media seed from components of the requested data key not present in the drive seed, for example.

In another example, the process may be extended to any number of drive seeds and/or media seeds. In this example, a drive seed may be selected from an array of drive seeds for different drives and a media seed may be selected from an array of media seeds for different media. A data key may be generated based on the selected drive seed and selected media seed. For example, the selected drive seed and the selected media seed may be combined or otherwise associated to create the data key. The data key thus created may be used to encrypt/decrypt data content. Also, the combination of the drive seed selected from different drives and the media seed selected from the array of media seed may be further described or indicated by an index. The index describing a matching between a drive seed and a media seed may be stored on a storage medium or may be stored in a sector header on the storage medium, for example. In this example, a client or host may specify a drive seed and media seed combination from an array of drive seeds and/or media seeds by specifying a corresponding index. The index may be cross referenced and the corresponding combination may be obtained. A data key may be generated based on the identified drive seed and media seed.

It is understood that aspects of the present description can take many forms and embodiments. The embodiments shown herein are intended to illustrate rather than to limit the description, it being appreciated that variations may be made without departing from the spirit of the scope of the invention. Although illustrative embodiments have been shown and described, a wide range of modification, change and substitution is intended in the foregoing disclosure and in some instances some features may be employed without a corresponding use of the other features. Accordingly, it is appropriate that the appended claims be construed broadly and in a manner consistent with the scope of the invention.

1. A method of recording data comprising:
receiving a data key from a client associated with data content;
identifying a drive seed corresponding to a drive based on the receiving;
determining a media seed based on the data key and the drive seed, the media seed associated with the data content;
storing the media seed corresponding to the data content;
receiving the data content which is encrypted according to the data key;
storing the data content.

2. The method of claim 1 further comprising decrypting the received data content prior to storing the data content.

3. The method of claim 1 further comprising authenticating at least one of the client and the drive.

4. The method of claim 3 wherein the authenticating includes creating a two-way authentication between the client and drive.

5. The method of claim 4 wherein the authenticating further includes encrypting the transfer of the data key between the client and the drive using the two-way authentication.

6. The method of claim 3 wherein authenticating the client includes:
receiving a host certificate from the client, the host certificate including at least one authorization bit;
identifying a setting of the at least one bit,
wherein identifying the data key is based on identifying the setting of the at least one bit.

7. The method of claim 6 wherein the step of identifying the data key comprises validating the data key according to the at least one authorization bit that the host may use the data key.

8. The method of claim 1 wherein the drive seed is at least statistically unique for the drive.

9. The method of claim 1 wherein the drive seed is statistically unique for a plurality of drives, wherein each drive in the plurality of drives is capable of deriving the same data key for a given media seed.

10. The method of claim 1 wherein the data content is stored on a storage medium and the step of storing the media seed includes storing the media seed on the storage medium.

11. The method of claim 10 wherein the storage medium is partitioned into a plurality of partitions, the media seed being selected from a plurality of media seeds, each of the media seeds in the plurality of media seeds corresponding to a partition in the plurality of partitions.

12. The method of claim 1 wherein the data key comprises a combination of the drive seed and the media seed.

13. The method of claim 1 wherein determining the media seed based on the data key and the drive seed involves includes executing a two-way function.

14. The method of claim 13 wherein the two-way function includes:
one of encrypting or decrypting the data key via the drive seed to generate the media seed; and
the other of encrypting or decrypting the media seed via the drive seed to generate the data key.

15. A method for encrypting data content via a data key comprising:
receiving a data input from a storage medium containing data content, the data input containing a media seed corresponding to the data content;
identifying a drive seed corresponding to a drive for reading the data content of the storage medium;
combining the media seed and the drive seed to generate a data key;
encrypting the data content based on the generated data key.

16. The method of claim 15 wherein the drive seed is private and non-accessible to an external entity.

17. The method of claim 15 wherein the drive seed is unique to a plurality of drives, wherein the drive is selected from the plurality of drives, each of the drives in the plurality of drives has the same drive seed.

18. The method of claim 15 wherein the storage medium is partitioned into a plurality of partitions.

19. The method of claim 18 wherein the media seed is selected from a plurality of media seeds, each of the media seeds in the plurality of media seeds corresponding to each of the partitions in the plurality of partitions.

20. A method for decrypting data content comprising:
receiving a data input from a storage medium containing data content, the data input containing a media seed corresponding to the data content, the data content being encrypted on the medium with the data key;
identifying a drive seed corresponding to a drive for reading the data content of the storage medium;
combining the media seed and the drive seed to generate a data key;
decrypting the data content based on the generated data key.
